(19) United States
(12) Patent Application Publication
(10) Pub. No.: US 2014/0170268 A1
(43) Pub. Date: Jun. 19, 2014

(54) CHUNKY PRODUCT IN ANIMAL FOOD COMPOSITIONS AND METHOD FOR PREPARING IT

(71) Applicants: Carsten Graeber, Kirchlinteln (DE); Jeanne Wiedenhoff, Bremen (DE); Thierry Six, Langlade (FR)

(72) Inventors: Carsten Graeber, Kirchlinteln (DE); Jeanne Wiedenhoff, Bremen (DE); Thierry Six, Langlade (FR)

(73) Assignee: MARS INCORPORATED, McLean, VA (US)

(21) Appl. No.: 13/988,850

(22) PCT Filed: Nov. 24, 2011
(86) PCT No.: PCT/EP11/05910

§ 371 Date: Jul. 10, 2013

(30) Foreign Application Priority Data
Nov. 30, 2010 (DE) 10 2010 052 923.0

(51) Int. Cl. A23K 1/10

(52) U.S. Cl. CPC A23K 1/10; A23K 1/103; A23K 1/106
USPC 426/72; 426/641; 426/644; 426/643

(57) ABSTRACT

The present application relates to a chunky product suitable for mixing in or as the sole component of animal food compositions, which comprises, in percent by weight based on the total weight of the chunky product: meat and/or animal by-products 10-55% by weight, further proteins 5-50% by weight, at least one water-binding component 0.5-15% by weight, optionally added water 10-30% by weight, wherein the chunky product comprises at least one phase in which all the proteins are present in substantially denatured form.

The present invention relates to a chunky product in animal food compositions and a method for preparing it.

Although there are a large number of different animal foods in a wide range of different forms available today, they can be roughly subdivided into two groups: first of all, conventional ready-to-serve animal food, consisting of a solid and a liquid phase, which as a rule means chunks of meat and a sauce surrounding the chunks; secondly, dry food, in the form of specially formed pellets which have been produced from a pulpy paste as a result of a substantial removal of water, for example by baking.

It has become apparent in this connection that in the case of ready-to-serve animal food consisting of chunks of meat and sauce, the solid ingredients in the food can easily become lodged between the animal's teeth, thus contributing to a considerable deterioration in oral hygiene. In addition, since the consistency of the food is very mushy or soft, it is not chewed, but is rather wolfed down; the food is not comminuted sufficiently in the oral cavity, which results in a burden on the digestion in the gastrointestinal tract. Since the animal eats more quickly and wolfs the food, the formation of saliva is inadequate, so that the oral cavity is inadequately cleaned of bacteria.

Dry food must be comminuted mechanically by intensive chewing, so that as a result of the chewing, dental plaque is reduced and the circulation of blood in the gingiva improves. Compared to moist food, however, dry food is not eaten so enthusiastically and may even be refused by the animal.

There have been some experiments aimed at preparing a chunky animal food without using chunks of meat. DE 2 728 512 A1 and DE 2 650 800 A1, for example, describe a moist food for pets containing, as one ingredient, heat-stable, meat-like chunks based on blood, and provide a recipe for those chunks, which is characterised by the presence of blood components and rubber. In both documents, the firmness of the chunks is determined by the addition of a defined amount of rubber. Optionally, as a further ingredient, an additional source of protein may be used, which may consist of animal or vegetable protein or mixtures thereof.

Finally, EP 1 119 264 B1 discloses a chunky product in animal food compositions and a method for preparing it. That chunky product comprises proteins, water-binding components, water and salt, wherein the proteins may originate from concentrated blood plasma, blood plasma powder, egg albumin powder, wheat gluten and soya protein. Cellulose may be used as the water-binding component. The chunky product known from this state of the art is prepared from quite expensive starting materials, especially protein and cellulose. In addition, there is still room for improvement over the chunky products known from the state of the art in preventing periodontitis and reducing dental plaque.

It is therefore an object of the present invention to provide a chunky product for animal food compositions which overcomes the disadvantages found in the state of the art, is in particular inexpensive to prepare and exhibits an improvement in preventing periodontitis/gingivitis and reducing dental plaque and calculus.

In addition, it is a further object of the invention to provide a method for preparing a chunky product of this kind.

The first object is achieved by a chunky product suitable for mixing in or as the sole component of animal food compositions, which comprises, in percent by weight based on the total weight of the chunky product: meat and/or animal by-products 10-55% by weight, preferably 35-55% by weight, further proteins 5-50% by weight, preferably 15-35% by weight, at least one water-binding component 0.5-15% by weight, optionally added water 10-30% by weight, wherein the chunky product comprises at least one phase in which the proteins are present in substantially denatured form.

Preferably, the chunky product comprises meat and/or animal by-products in an amount of 40-55, more preferably 45-55% by weight. Even preferred, further proteins are present in the inventive chunky product in an amount of 15-35% by weight. Also preferred, the at least one water-binding component is present in an amount of 3-10% by weight.

In the inventive chunky product, water may be optionally added. For example, if whole egg or milk is utilized as protein source, further addition of water is not necessary.

The chunky product comprises at least one phase in which the proteins are present in substantially denatured form. Proteins are present in substantially denatured form, if at least 85%, preferably 95%, of the proteins are in denatured form, most preferably, the proteins are fully denatured.

Preferably, the chunky product comprises only one phase.

The chunky product of the present invention only requires a low amount of water-binding components, such as starch. Starch is a main component when extrusion steps are required in order to obtain a desired texture structure. This is not necessary according to the present invention, as a protein binding is desired.

It is preferable here that the meat and/or the animal by-products are selected from the group consisting of liver, lean meat, meat meal, bone meal, poultry meal, fish meal and mixtures thereof. In accordance with the invention, the term “animal by-products” is intended to mean products, with the exception of blood plasma and/or blood plasma powder, which are obtained in the course of slaughtering the animal, but which are not pure (lean) meat products. Preferably, rawhide is not to be considered as animal by-product.

It is also preferably proposed that the further proteins are selected from the group consisting of powdered egg, whole egg, milk, milk powder, powdered egg white, wheat protein, soya, yeast and mixtures thereof. The expression “further proteins” is intended to mean proteins which are not encompassed by the definition of the expression “meat and/or animal by-products”. These proteins may certainly be animal in origin, such as whole egg, powdered egg, milk, milk powder or powdered egg white, but may also be vegetable in origin, such as wheat protein, soya or yeast.

The main sources of protein in the composition of the chunky product are preferably liver and powdered egg.

It is also in accordance with the invention that it has a fat content of 5-20% by weight, based on the total weight of the chunky product, which is optionally provided substantially by added fat/oil and/or by accompanying components of the meat and/or the animal by-products and/or the further proteins. The fat content for the chunky product of the invention is preferably provided substantially by whole egg, bone meal, meat meal, liver and/or starch. Even the addition of fat/oil as such is possible. It was found that, for example, addition of sunflower oil has no influence on texture properties.

As the chunky product is not prepared by using any extrusion steps, a higher fat content of 5-20% by weight is possible.

In a preferred embodiment, the at least one water-binding component is selected from the group consisting of starch, such as pea starch, rice starch, maize starch, wheat starch, potato starch, cassia gum, carrageenan and mixtures thereof, preferably starch. Starch is preferably present as at least one water-binding component, since the use of starch makes it possible for a particularly stable chunky product to be obtained and preserved even over a long storage period.

The chunky product of the invention is preferably characterised by a content of 1 to 10% by weight vegetable fibres, which are preferably selected from non-water-soluble vegetable fibres, preferably cellulose, beet chips, chicory, draff, lignin, pomace, molasses chips, cereal bran and mixtures thereof. The addition of vegetable fibres improves the hardness of the chunky product. In order to achieve a comparable hardness even without the addition of vegetable fibres, such as cellulose, it is, however, also possible to use a greater proportion of starch and/or protein. In the context of the present invention, vegetable fibres are not regarded as a water-binding component, since the water-binding components described as preferable exhibit a considerably greater water-binding capacity than vegetable fibres.

The chunky product optionally comprises further components, which are selected from phosphate, vitamins, trace elements, minerals and mixtures thereof.

Water may optionally be added to the chunky product of the invention in an amount of preferably 10-30% by weight. This is not essential, however; it is, for example, possible to use further water-containing proteins, such as whole egg or milk. All in all, the chunky product preferably has a total water content of 40 to 70% by weight. This total water content refers to the water content of the finished chunky product, i.e. after the completion of cooking and after sterilisation. The water content before the completion of cooking is, however, in a comparable range.

In a preferred embodiment, the chunky product is a one-phase product.

In another embodiment the chunky product can be a multi-phase product, preferably comprising a first phase and a second phase, wherein the first phase is preferably at least ten times, more preferably eighteen times more resistant to deformation than the second phase, or vice versa.

In this context, it is preferably proposed that the first phase should be an inner phase and the second phase an outer phase, or vice versa. A first phase can be, for example, based on an emulsion for preparing the chunky product as described above. A second phase may be provided by a standard steam formed meat emulsion. Both emulsions can be mixed by means of a pump and a rotating mixing head. This mixing head blends both emulsions. The faster the mixing heads rotate, the bigger is the blending of the emulsions and the marbling obtainable. Preferably, slow mixing heads are required to build larger layers.

Another aspect of the invention is a method for preparing the chunky product comprising the steps of: mincing meat and/or animal by-products in a fine grinder, mixing in the further components and optionally water, forming the mixture obtained in this way, preferably in the shape of strands, at least partially denaturing the mixture formed, cutting the formed and denatured mixture into pieces of an appropriate size, and packaging and sterilising, alone or possibly with other components. In the inventive method, mincing meat and/or animal by-products in a fine grinder is for emulsifying.

It is preferable in this connection that the denaturing step should include a temperature change and/or an alteration of the pH level.

Finally, it is preferably proposed that, in order to carry out the denaturing step, the temperature should be raised to at least 85° C.

The present invention is based on the surprising finding that, first of all, thanks to the special formulation of the chunky product of the invention, an animal food composition can be provided which, while comparable in texture, can be prepared considerably less expensively, with cost savings of 50 to 60%, compared to the chunky products known from the state of the art, especially from EP 1 119 264 B1. Secondly, the chunky product of the invention possesses advantageous properties in reducing dental plaque and calculus and preventing gingivitis. The chunky products of the invention also exhibit excellent flexibility.

It was also surprisingly found that upon storage of the chunky product, the texture properties even improved within the first weeks of storage.

In a factory for preparing moist food, the formulation of the invention for preparing the chunky product can be used without major investment costs, or can replace existing formulations. The chunky product of the invention, hereinafter referred to as “chunks” for short, can be added with no difficulty to a conventional moist food in a proportion of preferably at least 25%, so that the overall product can still always be marketed as a sole food.

Further features and advantages of the invention will become clear from the following detailed description of preferred embodiments, with reference to examples.

In order to illustrate the invention, two sample formulations of the invention and a comparative formulation were prepared. The ingredients and amounts used (percent by weight, based on the total amount of the chunky product) can be seen from the following Table 1.

TABLE 1

| | Comparative example | Example 1 | Example 2 |
|---|---|---|---|
| | % | % | % |
| Powdered egg white | 17.6 | | |
| Powdered egg | | 20 | 32.7 |
| Wheat flour | 25.5 | | |
| Pea starch | | 4 | 4 |
| Cellulose | 11.1 | 4 | 4 |
| Cassia gum | | 0.3 | 0.5 |
| Carrageenan | | 0.3 | 0.5 |
| Liver | | 37.0 | 37.0 |
| Sodium salt | 0.5 | | 0.5 |
| Bone meal & meat | | 13 | 6 |
| meal | | | |
| Added water | 45.3 | 21.4 | 14.8 |
| Total | 100.0 | 100.0 | 100.0 |

The formulations shown in the Table were processed as described in EP 1 119 264 B1, in order to result in a chunky product of the invention.

Based on the current costs of the ingredients of a chunky product, especially the costs of the protein and the cellulose, the chunky products according to Examples 1 and 2 could be produced with a cost saving of about 64% or 51% compared to the costs of preparing the comparative example.

Example 2 shows an increase in the hardness and tackiness (flexibility) of the chunks in terms of their texture compared to the comparative example, while Example 1 exhibits improved tackiness.

The chunks prepared in accordance with Example 1 were studied with regard both to the reduction in dental plaque and to the prevention of periodontitis. For these reasons, a wet pet food containing 35% by weight of the inventive chunky product was used in example 1. It was established that with the chunky product of the invention, a more substantial reduction in dental plaque and an improvement in the prevention of periodontitis was achieved compared to a chunky product prepared in accordance with the formulation of EP 1 119 264 B1.

On the basis of two groups of seven Miniature Schnauzer dogs, a first group was fed for a period of four weeks with a standard petfood, ready-to-serve, as can be purchased on the market. The second group was fed by the chunky products according to the present invention, also over a period of four weeks.

The above mentioned first group of dogs was then fed for four weeks with the wet petfood containing the inventive chunky products according to the present invention, while the above mentioned second group of dogs was fed with the standard petfood.

Feeding the chunky products of the present invention resulted in a statistically significant reduction in calculus of 22%, 82% reduction in gingivitis and 9% reduction in plaque when compared to feeding the standard petfood.

An analysis of the formulations shown in Table 1 with regard to the quantities of water, protein, fat, ash and fibres yielded the following figures (in percent by weight):

TABLE 2

| | Comparative example | Example 1 | Example 2 |
|---|---|---|---|
| Water | 65 | 53 | 56 |
| Protein | 12 | 21.5 | 20.4 |
| Fat | 0.7 | 8.9 | 12.1 |
| Ash | 0.8 | 2.8 | 2.8 |
| Fibres | 5.8 | 2.9 | 2.8 |

The ash content is formed by inorganic substances, such as minerals. The total of the ingredients shown in Table 2 does not add up to 100%. The products also contained further ingredients, though these were not analysed in detail.

The product of the invention was also used in a feeding test with 10 different dogs. In the test, a standard product was fed first while the feeding behaviour was filmed and the eating time measured. The standard product was an all-meat product. In a second feeding experiment, 25% of the chunky product of the invention was added to that standard product, and again the feeding behaviour was filmed and the eating time measured.

When the films and data were compared, a considerably longer eating time was found when the chunks of the invention were added, as can be seen from the following Table 3.

TABLE 3

| | | | | | Time taken to | Time taken to |
|---|---|---|---|---|---|---|
| | | | Amount of | Number | eat the food | eat the food |
| Dog | | | food given | of | (in s), 1st | (in s), 2nd |
| No.: | Dog breed | Food given | (in g) | chunks | feeding test | feeding test |
| 1 | Shi Tzu | Standard | 160 | | 1 min. 46 s | 1 min. 23 s |
| | | Standard + | 120 + 40 | 5 | 2 min. 13 s | 2 min. 44 s |
| | | chunk | | | | |
| 2 | Cocker | Standard | 180 | | 47 s | 39 s |
| | | Standard + | 135 + 45 | 6 | 52 s | 53 s |
| | | chunk | | | | |
| 3 | Jack Russel | Standard | 100 | | 17 s | 18 s |
| | Terrier | Standard + | 75 + 25 | 3 | 23 s | 24 s |
| | | chunk | | | | |
| 4 | Parson Russel | Standard | 180 | | 35 s | 42 s |
| | Terrier | Standard + | 135 + 45 | 6 | 52 s | 1 min. 2 s |
| | | chunk | | | | |
| 5 | Jack Russel | Standard | 170 | | 34 s | 54 s |
| | Terrier | Standard + | 128 + 43 | 5 | 52 s | 1 min. 3 s |
| | | chunk | | | | |
| 6 | English | Standard | 300 | | 52 s | 48 s |
| | Setter | Standard + | 225 + 75 | 10 | 49 s | 49 s |
| | | chunk | | | | |
| 7 | Labradoodle | Standard | 450 | | 45 s | 46 s |
| | | Standard + | 337 + 113 | 14 | 1 min. 11 s | 59 s |
| | | chunk | | | | |
| 8 | Border | Standard | 500 | | 1 min. 3 s | 1 min. 6 s |
| | Collie | Standard + | 375 + 125 | 16 | 1 min. 57 s | 1 min. 15 s |
| | | chunk | | | | |
| 9 | Cairn Terrier | Standard | 120 | | 21 s | 21 s |
| | | Standard + | 90 + 30 | 4 | 31 s | 24 s |
| | | chunk | | | | |
| 10 | Australian | Standard | 450 | | 1 min. 27 s | 1 min. 1 s |
| | Shepherd | Standard + | 337 + 113 | 15 | 2 min. 2 s | 1 min. 12 s |
| | | chunk | | | | |

In addition, it was found that the hardness and the tackiness of the chunks prepared improved still further over time. The tackiness and hardness, for example, still increased 12 weeks after preparation.

In a third feeding test the quality of the faeces of seven dogs was checked after they had been test-fed with the product of the invention for a lengthy period of time. No negative effects were found.

In accordance with the invention, it was also found that since the cellulose content was reduced or dispensed with completely, a reduction in the viscosity of the emulsion initially prepared can be achieved. This means that the emulsion can be kept for a longer time and can be pumped well during preparation.

The chunks of the invention can be prepared substantially in accordance with a method known from EP 1 119 264 B1. In the process, the mixed components of the formulation are, for example, blended in a mixer into liver which has first been finely minced and optionally mixed well with an appropriate amount of water. The emulsion is subsequently formed through nozzles onto a steam tunnel with the aid of a pump and cooked. The strands are cut and then preferably mixed with moist food. The moist food prepared, including the chunks, can then be sterilised in suitable packages (such as pouches, tins or aluminium trays).

It is important for the method of the present invention for preparing a chunky product that the mixture of the ingredients is not extruded, i.e. is not processed under heat and pressure in order to melt proteins and starch for expansion, but to just form the mixture (emulsion), preferably at a maximum temperature of 30° C., into the shape of strands or any other desired shape, and to heat the strands, obtained, e.g., onto a steam tunnel, at a tunnel temperature of preferably about 100° C., in order to obtain non-expanded chunks. The method of the present invention preferably does not comprise any extrusion step. In other words, a cold emulsion is first formed into strands, and these strands are then heated with steam to a temperature of about 100° C., for example in a steam tunnel or a water bath, a so-called thermal gelation.

In this regard, it is important to note that a minimum temperature of the chunky product is necessary to effect substantial denaturation of the proteins. The minimum temperature is preferably at least 85° C.

In contrast to many of prior art chunky products, the chunky products of the present invention shall keep the moisture, as they are to be mixed with wet petfood product, and the chunky products shall not collect any water. The chunky products of the present invention may be used for a wet complete animal food.

At the final step of sterilization according to the inventive method, the chunky product of the present invention does not degrade, as is typical for extruded snacks or dry petfood.

The features of the invention disclosed in the description and in the claims can be essential to implementing the invention in its various embodiments both individually and in any combination.

1. A chunky product suitable for mixing in or as the sole component of animal food compositions, which comprises, in percent by weight based on the total weight of the chunky product:

| | |
|---|---|
| meat and/or animal by-products | 10-55% by weight, |
| further proteins | 5-50% by weight, |
| at least one water-binding component | 0.5-15% by weight, |
| optionally added water | 10-30% by weight, |

wherein the chunky product comprises at least one phase in which all the proteins are present in substantially denatured form.

2. The chunky product as claimed in claim 1, wherein the meat and/or the animal by-products are selected from the group consisting of liver, lean meat, meat meal, bone meal, poultry meal, fish meal and mixtures thereof.

3. The chunky product as claimed in claim 1, wherein the further proteins are selected from the group consisting of powdered egg, whole egg, milk, milk powder, powdered egg white, wheat protein, soya, yeast and mixtures thereof.

4. The chunky product as claimed in claim 1, wherein the chunky product has a fat content of 5-20% by weight, based on the total weight of the chunky product.

5. The chunky product as claimed in claim 1, wherein at least one water-binding component is selected from the group consisting of starch, cassia gum, carrageenan and mixtures thereof.

6. The chunky product as claimed in claim 1, wherein the chunky product has a content of 1 to 10% by weight vegetable fibers.

7. The chunky product as claimed in claim 1, further comprising at least one components selected from the group consisting of phosphate, vitamins, trace elements, minerals and mixtures thereof.

8. The chunky product as claimed in claim 1, wherein it is a one-phase product.

9. A method for preparing a chunky product as claimed in claim 1, comprising the steps of:
mincing meat and/or animal by-products in a fine grinder,
mixing in the further components and optionally water,
forming the mixture thus obtained, preferably into the shape of strands,
at least partially denaturing the mixture formed,
cutting the formed and denatured mixture into appropriate sizes and packaging and sterilising them, alone or possibly with other components.

10. The method as claimed in claim 9, wherein the denaturing step includes a temperature change and/or an alteration of the pH level.

11. The method as claimed in claim 10, wherein in order to carry out the denaturing step, the temperature is raised to at least 85° C.

12. The chunky product as claimed in claim 4, wherein the fat is provided by a component selected from the group consisting of added fat/oil, by accompanying components of the meat, by the animal by-products, by the further proteins, and by combinations thereof.

13. The chunky product as claimed in claim 5, wherein the starch is selected from the group consisting of pea starch, rice starch, maize starch, wheat starch, potato starch, and combinations thereof.

14. The chunky product as claimed in claim 6, wherein the vegetable fibers are selected from non-water-soluble vegetable fibers, preferably cellulose, beet chips, chicory, draff, lignin, pomace, molasses chips, cereal bran and mixtures thereof.
